(19) United States
(12) Patent Application Publication
(10) Pub. No.: US 2007/0023423 A1
(43) Pub. Date: Feb. 1, 2007

(54) Production method of acoustic diaphragm, acoustic diaphragm, and speaker

(75) Inventors: Yoshiaki Suzuki, Kanagawa-ken (JP); Yoshiaki Tanaka, Kanagawa-ken (JP)

Correspondence Address: NATH & ASSOCIATES, 112 South West Street, Alexandria, VA, 22314, US

(73) Assignee: VICTOR COMPANY OF JAPAN, LIMITED., Yokohama (JP)

(21) Appl. No.: 11/492,948

(22) Filed: Jul. 26, 2006

(30) Foreign Application Priority Data
Jul. 27, 2005 (JP) P2005-217015
May 31, 2006 (JP) P2006-151699

(51) Int. Cl. H05B 6/10

(52) U.S. Cl. 219/633

(57) ABSTRACT

A production method of an acoustic diaphragm including the steps of: forming an acoustic diaphragm-shaped workpiece with a flange portion added to at least a portion of an outer periphery of the workpiece by using a natural material including an organic matter which can be carbonized by burning; impregnating a solution including phenol resin into the workpiece obtained at the above step, and then heating the workpiece to a predetermined temperature to bring the phenol resin into a high polymer state; and burning the workpiece processed at the above step under a substantially anoxic atmosphere to carbonize the organic matter.

### BACKGROUND OF THE INVENTION

1. Field of the Invention

The present invention relates to a method of producing a porous acoustic diaphragm having a high carbonization ratio, an acoustic diaphragm, and a speaker using the acoustic diaphragm.

2. Description of the Related Art

As an acoustic diaphragm for a speaker that outputs clear sound with small distortion, a porous diaphragm having a high carbonization ratio attracts attention in terms of the extent of internal losses.

However, in a production method of a diaphragm having a high carbonization ratio by burning a natural diaphragm material having various organic matters at a high temperature to carbonize the organic matters, deformations such as warpage and contortion as well as fracture are prone to be generated in the diaphragm at a resin impregnating step or at a burning step during the production process, and prevention thereof is a major technical issue.

The deformations such as warpage and contortion of the diaphragm shape as well as fracture and the like deteriorate the assembling precision as speaker parts and thus, the possibility of this kind of diaphragms being employed lowers.

For example, Japanese Patent (Publication) No. 2552577 discloses a conventional technique of obtaining a carbonized material by impregnating phenol resin in a cellulose-based material, and then performing burning and carbonization.

However, when this production method is employed for producing an acoustic diaphragm, countermeasure against the warpage, contortion, fracture, and the like which are surely generated is not taken into consideration. Therefore, the above conventional production method of the acoustic diaphragm is not appropriate. That is, it is extremely difficult to produce a practical acoustic diaphragm with this method.

Japanese Patent (Publication) No. 3008095 discloses a technique of forming a material while pressurizing the material by a mold, as the countermeasure against the warpage and the contortion at the time of burning operation, while a cellulose-based material is limited to a bamboo pulp.

However, the deformations at the time of impregnation of the phenol resin are not taken into consideration. In addition, the volume is reduced in the process of vaporization of oxygen, hydrogen, and the like other than carbon from the organic matter at the time of burning operation. Thus, the size largely differs from that of an initial organic matter, and the volume reduction ratio is varied depending on the burning temperature. However, contraction other than that in a thickness direction is not taken into consideration.

It is difficult to achieve a target size at the time of burning operation by a pressurizing mold disclosed in Japanese Patent (Publication) No. 3008095, and the method according to the publication is disadvantageous to be applied for the production method of the acoustic diaphragm in terms of yield. Further, to produce a plurality of products at the same time, the same number of molds must be prepared, which is disadvantageous in terms of cost and mass production.

Japanese Unexamined Patent Application Laid-Open (Koukai) No. S60(1985)-54596 discloses a technique of producing an acoustic diaphragm by impregnating thermoplastic resin into paper pulp, and burning the same. Although the object thereof is the same as that of the present application, warpage, contortion, and fracture generated during the process are not mentioned. Thus, an acoustic diaphragm having high precision and high mass productivity can not be obtained by the technique disclosed in this patent application.

In Japanese Examined Patent Application Publication (Koukoku) No. S57(1982)-11557, a material is a mixture of lignin, graphite powder, CMC (carboxymethyl cellulose), and after the material is formed into a diaphragm shape, it is heated and carbonized. A mold is used as a countermeasure against the warpage and contortion. This is for producing an acoustic diaphragm.

In Japanese Examined Patent Application Publication (Koukoku) No. S57(1982)-31356, a material is a phenol-based fiber, and phenol-based resin is impregnated into this fiber, formed into a diaphragm shape and is then heated and carbonized. A mold is used as a countermeasure against the warpage and contortion. This is for producing an acoustic diaphragm.

In Japanese Examined Patent Application Publication (Koukoku) No. S60(1985)-40756, a material is a phenol-based fiber, and phenol-based resin mixed with whisker fiber is impregnated into this fiber, formed into a diaphragm shape, and is then heated and carbonized. The material is a high polymer film, and a countermeasure against the warpage and contortion is not particularly mentioned.

In Japanese Unexamined Patent Application Laid-Open (Koukai) No. H7(1995)-329245, a material is a mixture of glass fiber, charcoal, and PVA (polyvinyl alcohol), the material is burned and carbonized, and a matrix is then formed so that warpage and contortion are not generated easily. The countermeasure against warpage and contortion at the time of production is not mentioned. Production of an acoustic diaphragm is one of the objects.

While all of Japanese Patent Application Publication Nos. S57-11557, S57-31356, and S60-40756 and Japanese Patent Application Laid-Open No. H7-329245 aim to obtain the acoustic diaphragm by burning, the materials are different from one another, and there is no countermeasure against the warpage, contortion, and fracture, or disclosed countermeasures are not sufficient.

### SUMMARY OF THE INVENTION

The present invention has been achieved in view of the above problems, and it is an object of the invention to reduce deformations of a diaphragm shape such as warpage and contortion at an impregnation step of resin and at a burning step during the production process of an acoustic diaphragm having a high carbonization ratio, and to reduce cost and to enhance mass productivity.

It is another object of the invention to enhance acoustic properties of a speaker using the acoustic diaphragm.

To achieve the above object, there is provided a production method of an acoustic diaphragm including the steps of: forming an acoustic diaphragm-shaped workpiece with a flange portion added to at least a portion of an outer periphery of the workpiece by using a natural material including an organic matter which can be carbonized by burning; impregnating a solution including phenol resin into the workpiece obtained at the above step, and then heating the workpiece to a predetermined temperature to bring the phenol resin into a high polymer state; and burning the workpiece processed at the above step under a substantially anoxic atmosphere to carbonize the organic matter.

The reason why the solution including the phenol resin is impregnated into the workpiece formed using the natural material is that the workpiece is prone to be broken if it is formed only of the natural material including the organic matter, and it is difficult to obtain a practical strength over a long term as a speaker diaphragm. Thus, the solution including the phenol resin is impregnated into the workpiece so that the practical strength is realized.

According to the present invention, since the deformations such as warpage and contortion during the impregnation step of resin and the burning step can be reduced, the precision of assembling the speaker is enhanced, thereby improving the speaker vibration characteristics which are conventionally deteriorated due to poor assembling precision.

According to the present invention, a press is not required when the workpiece is burned, the workpiece can be burned with high mechanical precision only by putting the workpiece into a baking furnace, and it is possible to enhance the productivity and to reduce cost.

A step of subjecting at least a portion of a surface of the workpiece to an air-leakage preventing processing to close a fine hole formed in the workpiece is provided after the step of carbonizing the organic matter. With this configuration, it is possible to prevent air at a front surface of the diaphragm from leaking toward the back surface of the diaphragm and to prevent air at the back surface of the diaphragm from leaking toward the front surface of the diaphragm. Thus, a basic performance as the acoustic diaphragm can be obtained easily.

It is preferable that a phenol resin solution is used in the air-leakage preventing processing.

At the step of forming the workpiece, in order to make a size of the workpiece become equal to a predetermined size after the burning, the workpiece is formed such that a size reduced by contraction at the time of burning is added to the predetermined size. With this configuration, it is possible to make the inner diameter of a hole at the center of the acoustic diaphragm and the outer diameter of a bobbin of a voice coil substantially equal to each other. Therefore, in assembling the speaker, it is possible to prevent an adhesive from excessively entering between the voice coil bobbin and the center of the acoustic diaphragm, and to avoid a case where the voice coil can not be inserted into the center of the acoustic diaphragm.

At the step of forming the workpiece, the workpiece is formed by milling and drying the workpiece in a nonpressurized state. With this, the thickness of the completed workpiece is increased while keeping flexibility thereof, the workpiece becomes strong against external force, and the mechanical strength is increased. Further, the acoustic diaphragm has high rigidity which is essential for acoustic diaphragms, and accordingly it is possible to provide a speaker having excellent acoustic properties.

The nature, principle and utility of the invention will become more apparent from the following detailed description when read in conjunction with the accompanying drawings.

### BRIEF DESCRIPTION OF THE DRAWINGS

In the accompanying drawings:

FIG. 1 is an explanatory diagram of a production method according to a first embodiment of the present invention;

FIGS. 2A to 2H are explanatory diagrams of the production method according to the first embodiment of the invention;

FIG. 3 is an explanatory diagram of a production method according to a second embodiment of the invention;

FIGS. 4A to 4H are explanatory diagrams of the production method according to the second embodiment of the invention;

FIG. 5 is an explanatory diagram of a production method according to a third embodiment of the invention;

FIGS. 6A to 6F are explanatory diagrams the production method according to the third embodiment of the invention;

FIG. 7 is an explanatory diagram of a production method according to a fourth embodiment of the invention;

FIGS. 8A to 8F are explanatory diagrams of the production method according to the fourth embodiment of the invention;

FIG. 9 is an explanatory diagram of a production method according to a fifth embodiment of the invention;

FIGS. 10A to 10H are explanatory diagrams of the production method according to the fifth embodiment of the invention;

FIG. 11 is an explanatory diagram of a production method according to a sixth embodiment of the invention;

FIGS. 12A to 12F are explanatory diagrams of the production method according to the sixth embodiment of the invention;

FIG. 13 is a cross section of a speaker apparatus according to a seventh embodiment of the invention;

FIGS. 14A and 14B are cross sections of an acoustic diaphragm according to the seventh embodiment of the invention;

FIGS. 15A and 15B are cross sections of the acoustic diaphragm according to the seventh embodiment of the invention;

FIGS. 16A and 16B are cross sections of the acoustic diaphragm according to the seventh embodiment of the invention; and

FIG. 17 is a diagram showing variation in sound velocities and internal losses by applying water-soluble phenol resin according to the invention.

### DESCRIPTION OF THE PREFERRED EMBODIMENTS

Embodiments of the present invention will be explained below.

<First Embodiment>

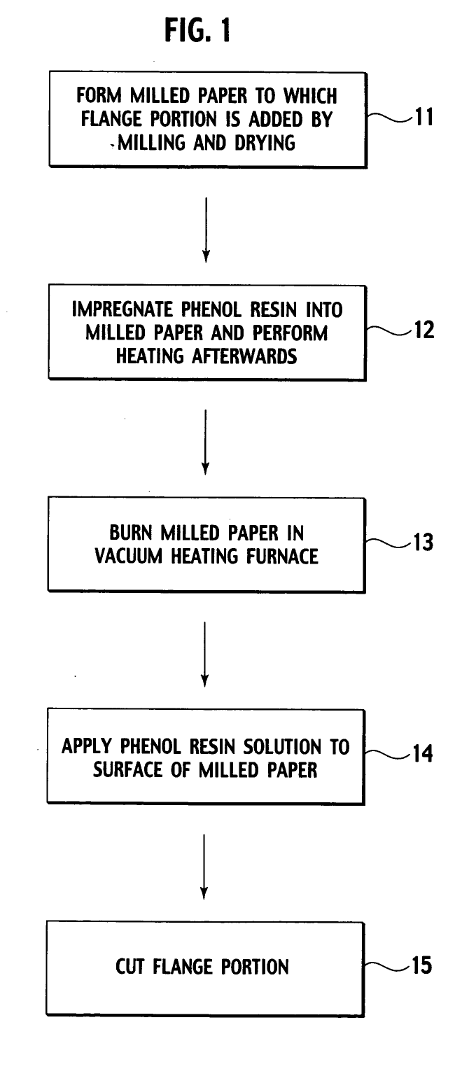

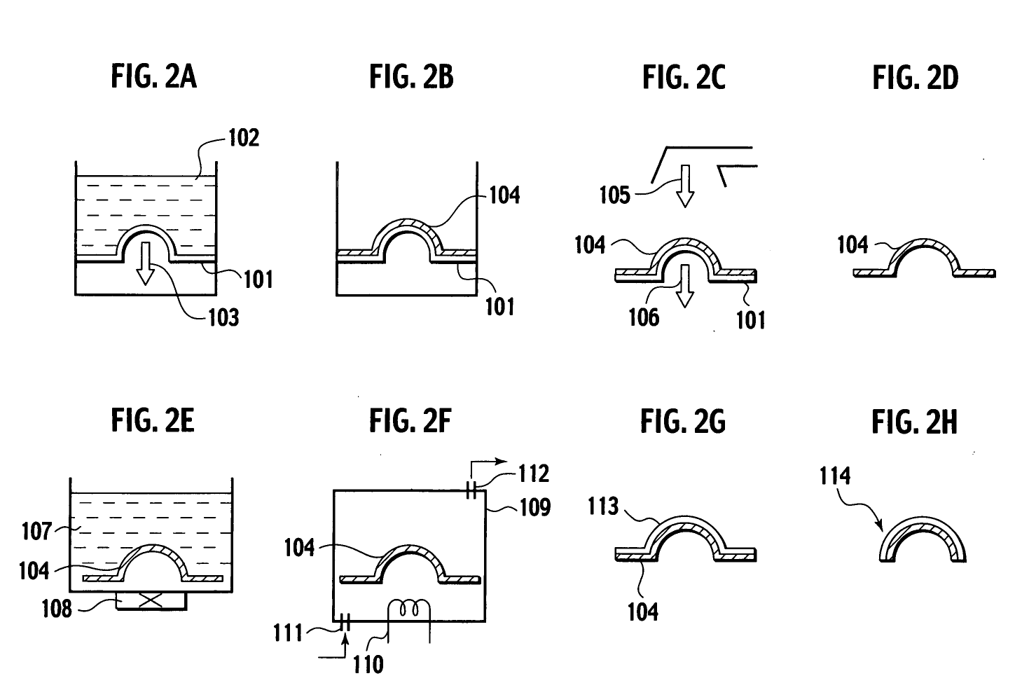

A first embodiment of the present invention will be explained first. FIGS. 1 and 2A to 2H are explanatory diagrams of a production method according to the first embodiment.

At a first step 11 in FIG. 1, as shown in FIG. 2A, a center portion is previously formed into a domical shape (hemispherical shape), a mesh 101 provided at its domical shape periphery with a flat (flange) portion is prepared (since the workpiece contracts by a burning operation, the mesh is formed larger than the size of the workpiece after the burning operation. For example, when it is heated at 800° C., contraction of, for example, 25% is taken into consideration, and the mesh is formed larger by this value). The mesh 101 is put into dispersion liquid 102 into which mixture fiber of 90 wt % of linter (cotton fiber) 10 wt %+NBKP [Needle Bleach Kraft Pulp] (softwood fiber is made into pulp by kraft process and is further exposed) is dispersed, and the mixture fiber is milled into paper on the mesh 101.

A reference number 103 in FIG. 2A represents a suction direction when paper is milled, and a reference number 104 in FIG. 2B represents milled paper.

The mesh 101 can be made of metal such as brass, but the material is not limited to this, and any strong material with heat resistance can be used. For example, copper and iron can be used. Particularly, iron-based stainless steel is frequently used since it does not rust.

To remove moisture from the milled paper 104 on the mesh 101, hot air 105 (e.g., in a range of 100° C. to 200° C., for example 150° C.) is blown on the milled paper 104 and the mesh 101 is vacuum-sucked from below at the same time as shown in FIG. 2C. A reference number 106 in FIG. 2C represents the vacuum-suction air flow.

The dried milled paper 104 from which moisture is eliminated has a weight ratio of the domical portion and the peripheral flat (flange) portion at that time was about 1:5 at this time.

At a second step 12 in FIG. 1, the milled paper 104 is detached from the mesh 101 as shown in FIG. 2D, and is immediately immersed in alcohol solution 107 of phenol resin (phenol resin containing ratio is about 15%) as shown in FIG. 2E, and the alcohol solution 107 is impregnated. At that time, the entire alcohol solution 107 of phenol resin is subjected to ultrasonic oscillation for about five minutes by an ultrasonic oscillator 108 for example, so that the alcohol solution 107 well enters into the milled paper 104.

The milled paper 104 is taken out from the solution 107 and sufficiently dried: and the milled paper 104 is then heated for about ten minutes at about 180° C. so that the phenol resin which is a short molecule is brought into a high polymer state.

The weight after the phenol resin is brought into the high polymer state at this step is increased by about two times as compared with a value before impregnation of phenol resin using the initial natural material only.

Next, at a third step 13 in FIG. 1, as shown in FIG. 2F, the milled paper 104 in which phenol resin is impregnated is placed in a vacuum heating furnace 109, and is heated from a room temperature to 800° C. by a heater 110 in an anoxic atmosphere (e.g., nitrogen gas atmosphere). After the milled paper 104 is held for 30 minutes at 800° C., it is gradually cooled to the room temperature and is taken out from the furnace. With this step, the organic matter included in the milled paper 104 is carbonized. Thus, a large number of fine holes are formed in the milled paper 104 so as to be porous.

The weight reduces by the burning step by about 20 w % as compared with a value before the burning step.

A reference number 111 in FIG. 2F represents an introduction port for nitrogen gas or the like, and a reference number 112 represents a discharge port for nitrogen gas or the like.

Next, at a fourth step 14 in FIG. 1, as shown in FIG. 2G, water-soluble phenol resin solution is applied to a surface of the milled paper 104 to fill the same, so as to prevent air from leaking when it is formed into an acoustic diaphragm, thereby providing the milled paper 104 with a function as the acoustic diaphragm. A reference number 113 in FIG. 2G represents a filling layer.

The weight is increased due to the water-soluble phenol resin by about 20 w % as compared with a value before the water-soluble phenol resin is applied. By applying the water-soluble phenol resin, the sound velocity increases remarkably (by about 30%) as compared with a value before the water-soluble phenol resin is applied, and an excellent function as the acoustic diaphragm can be provided.

Variation in the sound velocity when other general resin or the like is applied to fill the mesh, is increased only by 10% or less at most.

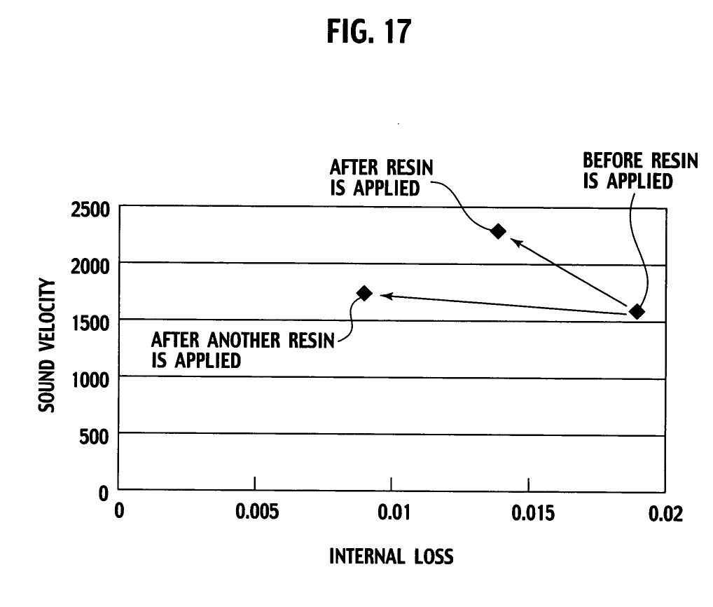

FIG. 17 shows variation in the sound velocity and internal losses when water-soluble phenol resin is applied.

Relation between the acoustic diaphragm and the sound velocity will be described.

Making a high band resonance frequency derived from the material and the shape of the acoustic diaphragm as high as possible is same as eliminating a grating peak sound created by the high band resonance frequency from the acoustic diaphragm, to make the grating sound a comfortable sound. This is a common technical idea both for a high tone acoustic diaphragm and a low tone acoustic diaphragm. The sound velocity in the physical properties of the acoustic diaphragm determines the high band resonance frequency. As the sound velocity becomes faster, the high band resonance frequency becomes higher.

As shown in FIG. 17, with respect to the physical properties after the phenol resin of the present invention is applied, the sound velocity is faster and the reduction of the internal loss is smaller as compared with the physical properties after other resins are applied. That is, the sound velocity of sound is fast and the internal loss is high. Thus, a grating sound is less prone to be generated, and even if the grating sound is generated, excessive vibration can appropriately be absorbed, and a more ideal material for the diaphragm can be obtained.

Therefore, the increase in the sound velocity makes the high band resonance frequency higher, and makes the acoustic diaphragm excellent as a result.

That is, the basics of the acoustic diaphragm are to efficiently push and pull air existing at a front surface of the diaphragm according to an input electric signal. For this purpose, it is preferable that air-leakage preventing processing is adopted to completely eliminate the air-leakage, and air at the front surface of the diaphragm is prevented from leaking toward the back surface of the diaphragm or air at the back surface of the diaphragm is prevented from leaking toward the front surface of the diaphragm.

Next, at a fifth step 15 in FIG. 1, as shown in FIG. 2H, the flat portion of the flange of the filled milled paper 104 is cut and eliminated.

When paper is milled at the first step 11 in FIG. 1 (at the time of FIG. 2A), if a small step is previously formed at a boundary between the domical portion and the flange portion of the milled paper 104, it can be cut by a grinding cutter (cutting tool using a rotating grindstone), a laser cutter, or the like using the small step as a guideline, so it is possible to precisely eliminate the flange portion and to obtain a precise shape.

No warpage, contortion, or fracture is found in the acoustic diaphragm 114 completed in this manner.

This production method does not require a press in the burning operation, and the burning operation having high mechanical precision can be carried out only by putting the milled paper into the baking furnace, and the mass productivity can be enhanced and the cost can be reduced.

In this embodiment, the acoustic diaphragm is formed by milling and drying in a nonpressurized state. This method employs a so-called non-press forming method. According to this method, warpage and contortion in particular are reduced and the acoustic properties become excellent.

In the paper milling and drying formation in the nonpressurized state, that is, in the non-press forming method, the press processing by a mold is not carried out at the time of paper milling and drying. The completed molded product keeps the state same as when paper is milled, with a small density and a large thickness.

If this thick non-press molded product is subjected to the burning step of the present invention, the molded product is contracted in its thickness direction. Although it is contracted, it is very thick as compared with a so-called press cone. If sufficient thickness is required after the burning step, this non-press forming method is employed.

This thick burned diaphragm is strong against external force and has strong mechanical strength, and has high rigidity which is essential for acoustic diaphragms, thereby providing a speaker having excellent acoustic properties.

While it is preferable to use nitrogen gas as the anoxic atmosphere because it is inexpensive and is readily available, argon, high vacuum atmosphere, and the like can be used other than the nitrogen gas.

<Second Embodiment>

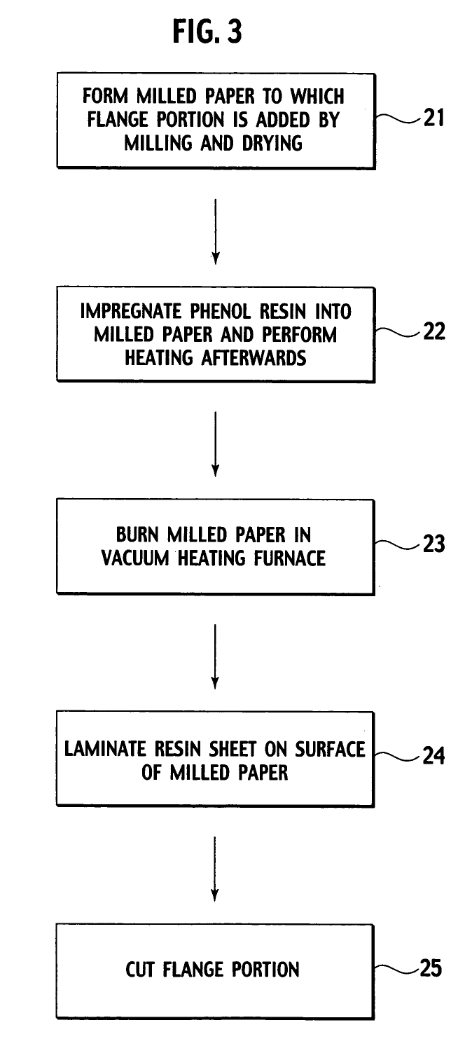

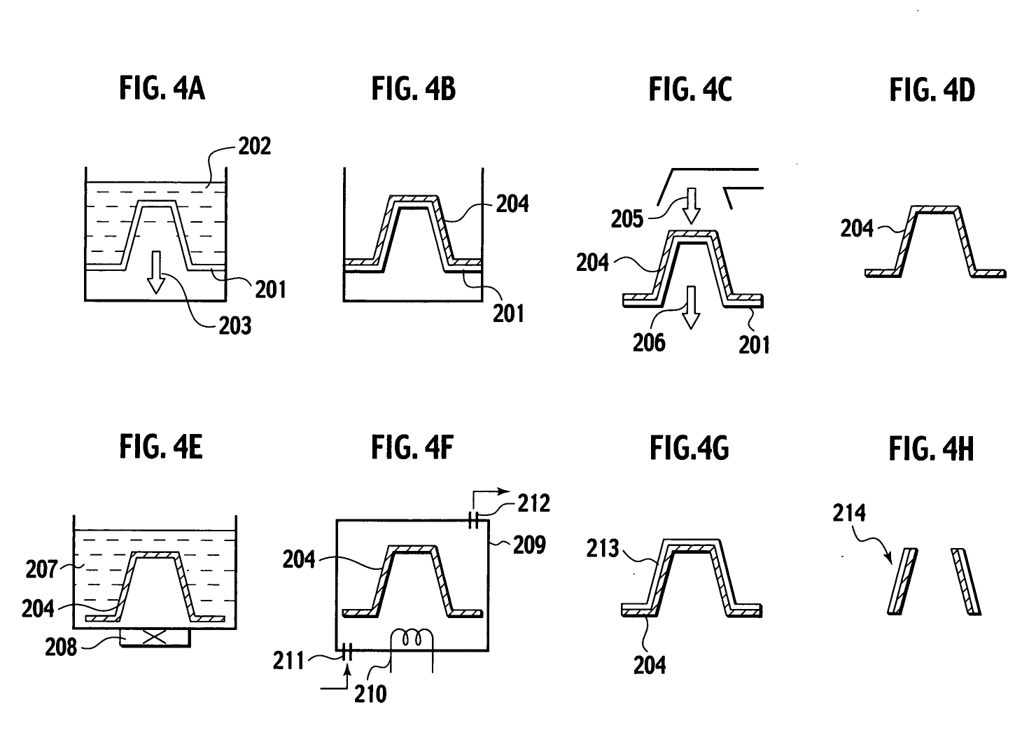

A second embodiment of the invention will be explained. FIGS. 3 and 4A to 4H are explanatory diagrams of a production method according to the second embodiment.

At a first step 21 in FIG. 3, as shown in FIG. 4A, a center portion is previously formed into a conical shape (truncated shape), and a mesh 201 whose lower end is formed with a flat (flange) portion over its entire periphery is prepared (since a workpiece is contracted by a burning operation, the mesh is formed larger than the size of the workpiece after the burning operation. For example, when it is heated at 800° C., contraction of 25% is taken into consideration, and the mesh is formed larger by this value). The mesh 201 is put into dispersion liquid 202 into which mixture fiber of 90 wt % of linter (cotton fiber) 10 wt %+NUSP [Needle Unbleach Sulfite Pulp] (softwood fiber is made into pulp by sulfite process and is not exposed) is dispersed, and the mixture fiber is milled into paper on the mesh 201.

A reference number 203 in FIG. 4A represents a suction direction at the time of milling of paper, and a reference number 204 in FIG. 4B represents milled paper. The mesh 201 can be made of metal such as brass, but the material is not limited to this, and any strong material with heat resistance can be used.

To remove moisture from the milled paper 204 on the mesh 201, hot air 205 obtained by burning gas (e.g., in a range of 100° C. to 200° C., for example 150° C.) is blown on the milled paper 204 and the mesh 201 is vacuum-sucked from below at the same time as shown in FIG. 4C. A reference number 206 in FIG. 4C represents the vacuum-suction air flow.

If gas is used for removing moisture, temperature is prone to rise as compared with electric heating, and the productivity becomes excellent and is therefore preferable. In the milled paper 204 from which moisture is removed and which is dried, a weight ratio of the conical portion and a total of this portion and a center flat (flange) portion added to the peripheral flat (flange) portion is about 1:1.2 at this time.

At a second step 22 in FIG. 3, the milled paper 204 is detached from the mesh 201 as shown in FIG. 4D, and is immediately immersed in alcohol solution 207 of phenol resin (ratio of phenol resin is about 15%) as shown in FIG. 4E, and the alcohol solution 207 is impregnated therein. At that time, the entire alcohol solution 207 of phenol resin is subjected to supersonic oscillation for five minutes for example by an ultrasonic oscillator 208 so that the solution 207 well enters the milled paper 204.

The milled paper 204 is taken out from the solution 207 and is sufficiently dried, and it is heated for about 15 minutes while observing the dry state at relatively low temperature of about 170° C., and the phenol resin which is a short molecule is brought into a high polymer state.

At this step, the weight after the phenol resin is brought into the high polymer state is increased by about two times as compared with a value before phenol resin of only an initial natural material is impregnated.

Next, at a third step 23 in FIG. 3, as shown in FIG. 4F, the milled paper 204 in which phenol resin is impregnated is placed in a vacuum heating furnace 209, and is heated from a room temperature to 800° C. by a heater 210 in a substantially anoxic atmosphere (e.g., nitrogen gas atmosphere). After the milled paper 204 is held for 30 minutes at 800° C., it is gradually cooled to the room temperature and is taken out from the furnace. With this step, the organic matter included in the milled paper 204 is carbonized. Thus, a large number of fine holes are formed in the milled paper 204 so as to be porous.

The weight reduces by the burning step by about 20 w % as compared with a value before the burning step.

A reference number 211 in FIG. 4F represents an introduction port for nitrogen gas, and a reference number 212 represents a discharge port for nitrogen gas. Argon gas or high vacuum atmosphere may be used instead of the nitrogen gas.

Next, at a fourth step 24 in FIG. 3, as shown in FIG. 4G, a thin sheet 213 made of polypropylene resin and the like, for example, a sheet having 0.01 to 0.1 mm thickness is laminated on a surface of the milled paper 204, thereby performing air-leakage preventing processing to provide a function as the acoustic diaphragm.

At a fifth step 25 in FIG. 3, as shown in FIG. 4H, the flat portion of the flange of the milled paper 204 is eliminated by cutting.

When paper is milled at the first step 21 in FIG. 3 (at the time of FIG. 4A), if a small step is previously formed at a boundary between the conical portion and the flange portion of the milled paper 204, it can be cut by a grinding cutter (cutting tool using a rotating grindstone), a laser cutter, or the like using the small step as a guideline, so it is possible to precisely eliminate the flange portion and to obtain a precise shape.

No warpage, contortion, or fracture is found in the acoustic diaphragm 214 completed in this manner.

This production method does not require a press in the burning operation, and the burning operation having high mechanical precision can be carried out only by putting the milled paper into the baking furnace, and the mass productivity can be enhanced and the cost can be reduced.

In this embodiment, the acoustic diaphragm is formed by milling and drying in a nonpressurized state. This method employs a so-called non-press forming method. According to this method, warpage and contortion in particular are reduced and the acoustic properties become excellent.

<Third Embodiment>

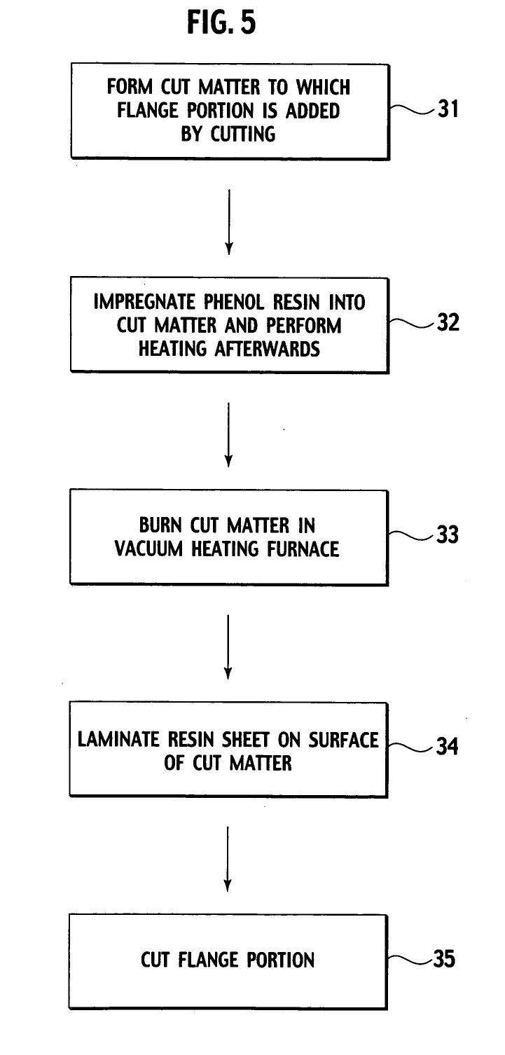

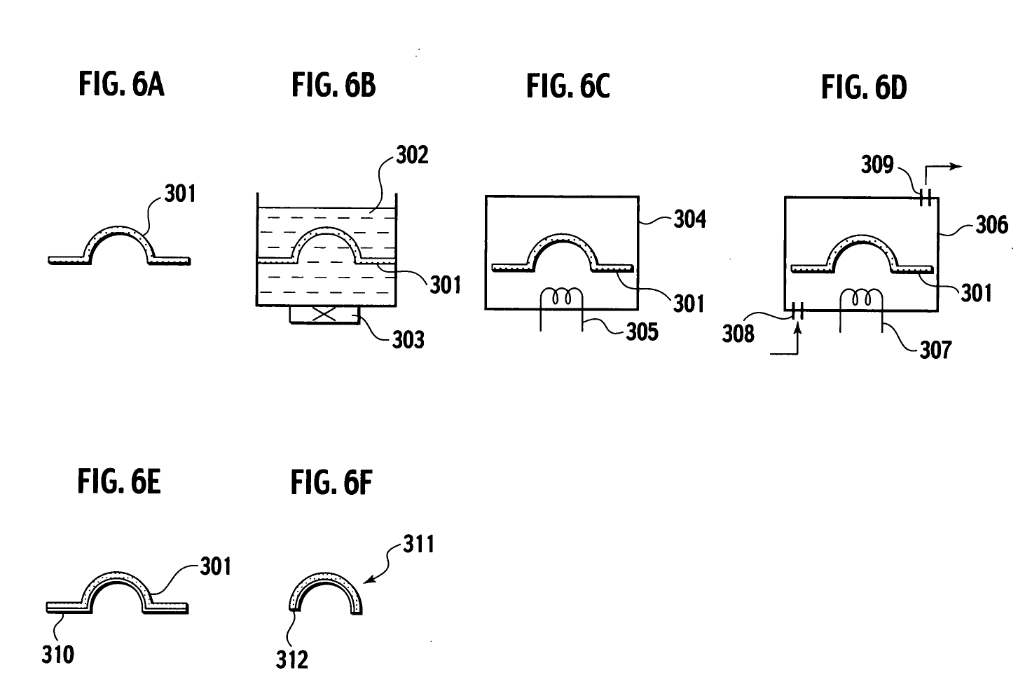

A third embodiment of the invention will be explained next. FIGS. 5 and 6A to 6F are explanatory diagrams of a production method according to the third embodiment.

At a first step 31 in FIG. 5, a block of a paulownia which is a broad-leaved tree is cut, thereby obtaining a cut matter 301 with a domical portion and its peripheral flat (flange) portion as shown in FIG. 6A (since the domical portion is contracted by the burning operation, this portion is formed larger than the size thereof after the burning operation. In this case, since it is heated at 1100° C., the contraction of 26% is taken into consideration, and the domical portion is formed larger by this value). At that time, the weight ratio between the domical portion and the flange portion is 1:2.

At a second step 32 in FIG. 5, as shown in FIG. 6B, the cut matter 301 is immersed in alcohol solution 302 of phenol resin (ratio of phenol resin is about 15%), and the solution 302 is impregnated therein. At that time, the entire phenol solution 302 in which the cut matter 301 is immersed is subjected to supersonic oscillation for five minutes for example by an ultrasonic oscillator 303 so that the solution 302 well enters the cut matter 301.

The cut matter 301 is taken out from the solution 302 and is sufficiently dried, and it is placed in a heating furnace 304 and heated for about 15 minutes, for example, at about 180° C. by a heater 305 as shown in FIG. 6C, and the phenol resin which is a short molecule is brought into a high polymer state.

At this step, the weight variation after the phenol resin is brought into the high polymer state is increased by about 50 w % as compared with a value before phenol resin of only an initial natural material is impregnated.

Next, at a third step 33 in FIG. 5, as shown in FIG. 6D, the cut matter 301 in which phenol resin is brought into a high polymer state is placed in a vacuum heating furnace 306, and it is heated from a room temperature to 1100° C. by a heater 307 in an anoxic atmosphere (e.g., nitrogen gas atmosphere). After the cut matter 301 is held for 60 minutes at 1100° C., it is gradually cooled to the room temperature and is taken out from the furnace. With this step, the organic matter included in the cut matter 301 is carbonized. Thus, a large number of fine holes are formed in the cut matter 301 so as to be porous.

The weight reduces by the burning step by about 30 w % as compared with a value before the burning step.

A reference number 308 in FIG. 6D represents an introduction port for nitrogen gas, and a reference number 309 represents a discharge port for nitrogen gas. Argon gas or high vacuum atmosphere may be used instead of the nitrogen gas.

At a fourth step 34 in FIG. 5, as shown in FIG. 6E, a thin resin sheet 310 made of a predetermined material is laminated on a surface of the cut matter 301 at a slightly high temperature, thereby preventing air from leaking when it is formed as an acoustic diaphragm, and providing a function as the acoustic diaphragm.

At a fifth step 35 in FIG. 5, as shown in FIG. 6F, the flat portion of the flange portion of the cut matter 301 is eliminated by cutting, thereby forming an acoustic diaphragm 311. A reference number 312 represents a cut trace of the flange portion.

At the time of the cutting operation at the first step 31 in FIG. 5 (at the time of FIG. 6A), if a small step is previously formed at a boundary between the domical portion and the flange portion of the cut matter 301, it can be cut by a grinding cutter (cutting tool using a rotating grindstone), a laser cutter, or the like using the small step as a guideline, so it is possible to precisely eliminate the flange portion and to obtain a precise shape.

No warpage, contortion, or fracture is found in the acoustic diaphragm 311 completed in this manner.

This production method does not require a press in the burning operation, and the burning operation having high mechanical precision can be carried out only by putting the milled paper into the baking furnace, and the mass productivity can be enhanced and the cost can be reduced.

<Fourth Embodiment>

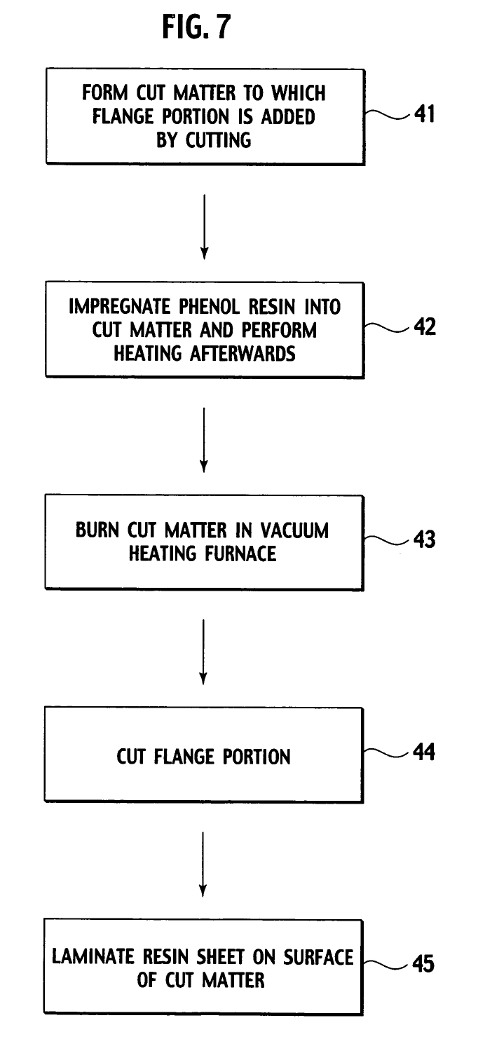

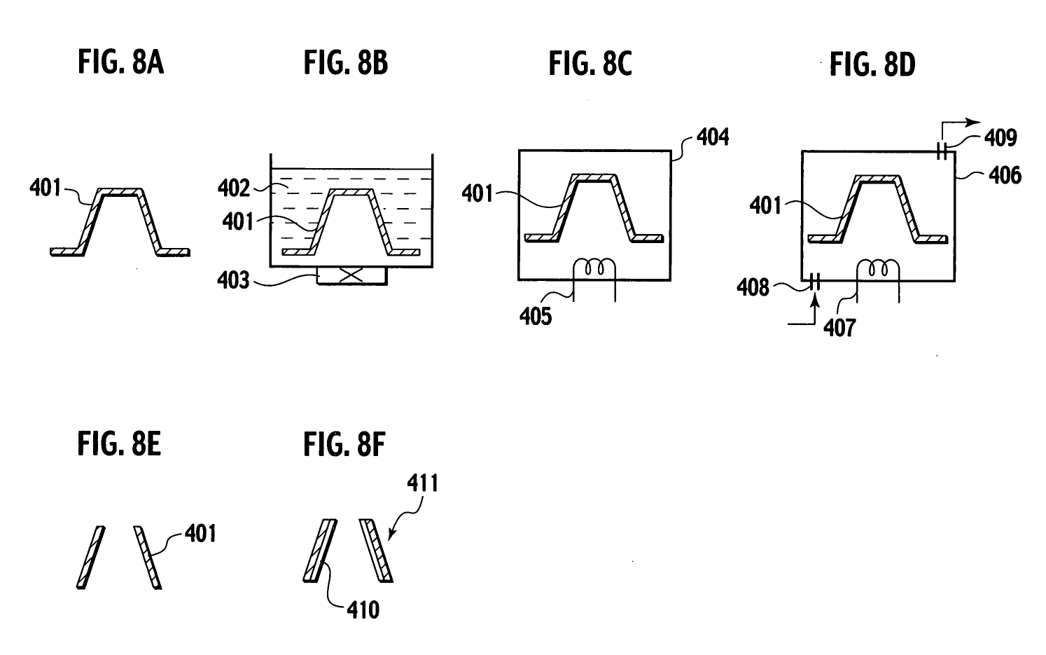

A fourth embodiment of the invention will be explained next. FIGS. 7 and 8A to 8F are explanatory diagrams of a production method according to the fourth embodiment.

At a first step 41 in FIG. 7, a block of a cypress which is a softwood is cut, thereby obtaining a cut matter 401 having a conical (truncated) portion and a flat (flange) portion formed at its lower end entire periphery as shown in FIG. 8A (since the conical portion is contracted by the burning operation, this portion is formed larger than the size thereof after the burning operation. In this case, since it is heated at 800° C., contraction of 25% is taken into consideration, and the portion is formed larger by this value). At that time, the weight ratio between the conical portion and the flange portion is 1:1.5.

At a second step 42 in FIG. 7, as shown in FIG. 8B, the cut matter 401 is immersed in alcohol solution 402 of phenol resin (ratio of phenol resin is about 15%), and the solution 402 is impregnated therein. At that time, the entire phenol solution 402 in which the cut matter 401 is immersed is subjected to supersonic oscillation for five minutes for example by an ultrasonic oscillator 403 so that the solution 402 well enters the cut matter 401.

The cut matter 401 is taken out from the solution 402 and is sufficiently dried, and it is placed in a heating furnace 404 and heated for about 15 minutes, for example, at about 180° C. by a heater 405 as shown in FIG. 6C, and the phenol resin which is a short molecule is brought into a high polymer state.

At this step, the weight variation after the phenol resin is brought into the high polymer state is increased by about 50 w % as compared with a value before phenol resin of only an initial natural material is impregnated.

Next, as shown in FIG. 8D, at a third step 43 in FIG. 7, the cut matter 401 in which phenol resin is brought into a high polymer state is placed in a vacuum heating furnace 406, and it is heated from a room temperature to 800° C. by a heater 407 in an anoxic atmosphere (e.g., nitrogen gas atmosphere). After the cut matter 401 is held for 30 minutes at 800° C., it is gradually cooled to the room temperature and is taken out from the furnace. With this step, the organic matter included in the cut matter 401 is carbonized. Thus, a large number of fine holes are formed in the cut matter 401 so as to be porous.

The weight reduces by the burning step by about 30 w % as compared with a value before the burning step.

A reference number 408 in FIG. 8D represents an introduction port for nitrogen gas, and a reference number 409 represents a discharge port for nitrogen gas. Argon gas or high vacuum atmosphere may be used instead of the nitrogen gas.

Next, at a fourth step 44 in FIG. 7, as shown in FIG. 8E, the flat portion of the cut matter 401 is eliminated by cutting.

At the time of the cutting operation at the first step 41 in FIG. 7 (at the time of FIG. 8A), if a small step is previously formed at a boundary between the conical portion and the flange portion of the cut matter 401, it can be cut by a grinding cutter (cutting tool using a rotating grindstone), a laser cutter, or the like using the small step as a guideline, so it is possible to precisely eliminate the flange portion and to obtain a precise shape.

At a fifth step 45 in FIG. 7, as shown in FIG. 8F, for example, a water-soluble resin liquid is applied to a surface of the cut matter 401 to make this surface flat, and a resin sheet 410 is laminated similarly to the previous explanation, thereby completing an acoustic diaphragm 411.

No warpage, contortion, or fracture is found in the acoustic diaphragm 411 completed in this manner.

This production method does not require a press in the burning operation, and the burning operation having high mechanical precision can be carried out only by putting the milled paper into the baking furnace, and the mass productivity can be enhanced and the cost can be reduced.

<Fifth Embodiment>

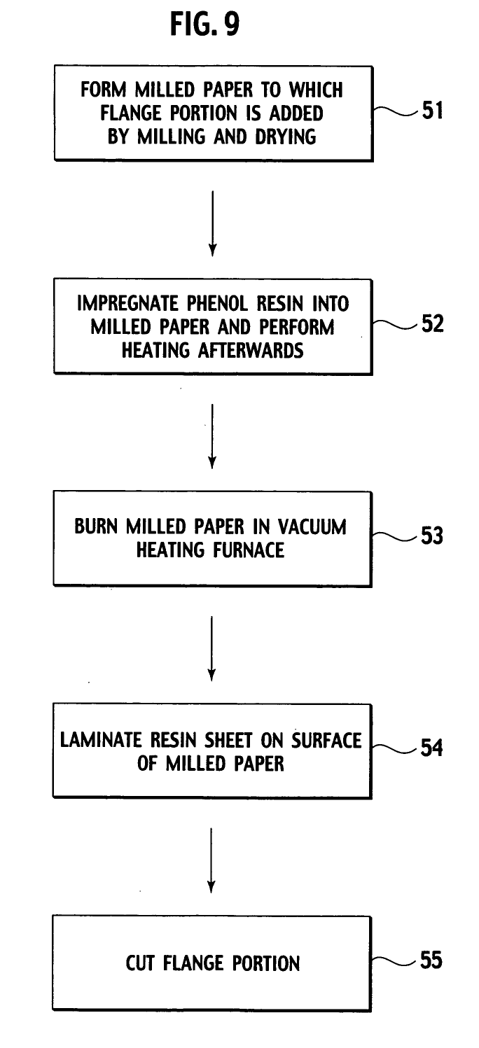

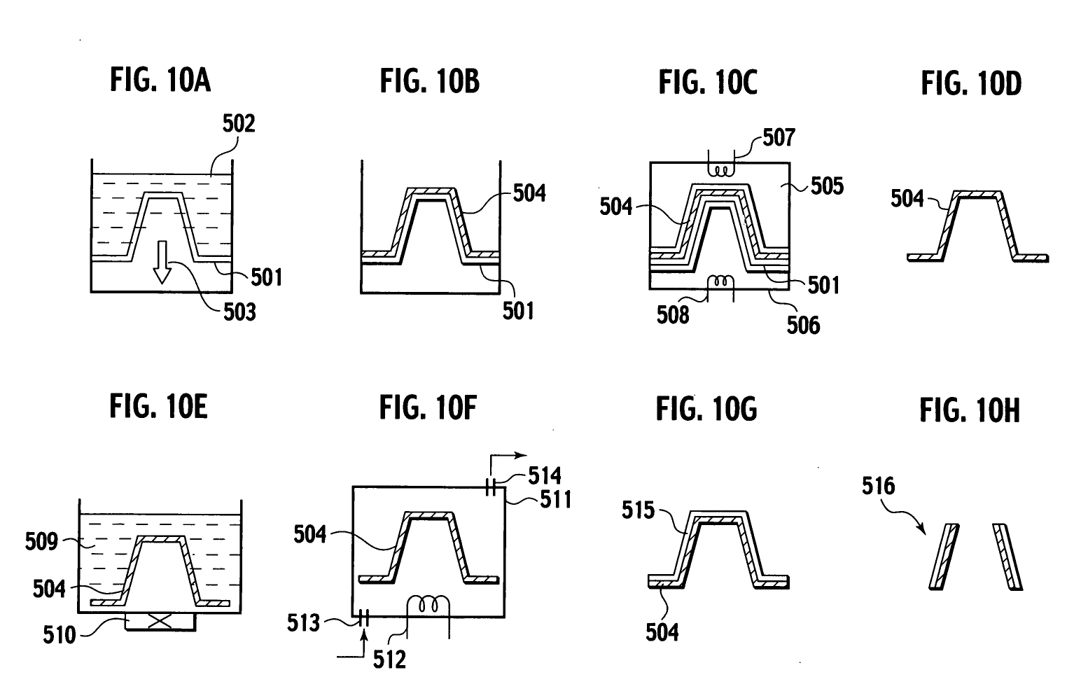

A fifth embodiment of the invention will be explained next. FIGS. 9 and 10A to 10H are explanatory diagrams of a production method according to the fifth embodiment.

At a first step 51 in FIG. 9, as shown in FIG. 10A, a center portion is previously formed Into a conical (truncated) shape and a mesh 501 whose lower end is formed with a flat (flange) portion at the lower end over its periphery is prepared (since the workpiece is contracted by the burning operation, this portion is formed larger than the size thereof after the workpiece is burned. In this case, since it is heated at 800° C., contraction of 25% is taken into consideration, and this portion is formed larger by this value). The mesh 501 is put into dispersion liquid 502 into which mixture fiber of 90 wt % of linter (cotton fiber) 10 wt %+NUSP is dispersed, and the mixture fiber is milled into paper on the mesh 501.

A reference number 503 in FIG. 10A represents a suction direction at the time of milling of paper, and a reference number 504 in FIG. 10B represents the milled paper. The mesh 501 can be made of metal such as brass, but the material is not limited to this, and any strong material with heat resistance can be used.

To remove moisture from the milled paper 504 on the mesh 501, as shown in FIG. 10C, the milled paper 504 is sandwiched between upper and lower molds 505 and 506 heated to a predetermined temperature, and the milled paper 504 is heated by heaters 507 and 508 while being pressurized. The weight ratio of the conical portion and the center flat portion to which the peripheral flat (flange) portion is added of the dried milled paper 504 from which moisture is sufficiently removed is about 1:0.5.

At a second step 52 in FIG. 9, as shown in FIG. 10D, the milled paper 504 detached from the mesh 501 is immediately immersed in alcohol solution 509 of phenol resin (ratio of phenol resin is about 15%) as shown in FIG. 10E, and the solution 509 is impregnated therein. The entire phenol solution 509 is subjected to supersonic oscillation for five minutes for example by an ultrasonic oscillator 510 so that the solution 509 well enters the milled paper 504.

The milled paper 504 is taken out from the solution 509 and is sufficiently dried, and it is heated for 10 minutes for example at about 180° C., and the phenol resin which is a short molecule is brought into a high polymer state.

At this second step 52, the weight after the phenol resin is brought into the high polymer state is increased by two times as compared with a value before phenol resin of only an initial natural material is impregnated.

Next, at a third step 53 in FIG. 9, as shown in FIG. 10F, the milled paper 504 in which phenol resin is brought into a high polymer state is placed in a vacuum heating furnace 511, and it is heated from a room temperature to 800° C. by a heater 512 in an anoxic atmosphere (e.g., nitrogen gas atmosphere). After the milled paper 504 is held for 30 minutes at 800° C., it is gradually cooled to the room temperature and is taken out from the furnace. With this step, the organic matter included in the milled paper 504 is carbonized. Thus, a large number of fine holes are formed in the milled paper 504 so as to be porous.

The weight reduces by the burning step by about 20 w % as compared with a value before the burning step.

A reference number 513 in FIG. 10F represents an introduction port for nitrogen gas, and a reference number 514 represents a discharge port for nitrogen gas. Argon gas or high vacuum atmosphere may be used instead of the nitrogen gas.

Next, at a fourth step 54 in FIG. 9, as shown in FIG. 10G, a thin sheet 515 made of, for example, polypropylene resin is laminated on a surface of the milled paper 504, thereby preventing air from leaking when it is formed as an acoustic diaphragm, and providing a function as the acoustic diaphragm.

At a fifth step 55 in FIG. 9, as shown in FIG. 10H, the flat portion of the burned milled paper 504 is eliminated by cutting.

At the time of the milling of paper at the first step 51 in FIG. 9 (at the time of FIG. 10A), if a small step is previously formed at a boundary between a conical body and the flange portion of the milled paper 504, it can be cut by a grinding cutter (cutting tool using a rotating grindstone), a laser cutter, or the like using the small step as a guideline, so it is possible to precisely eliminate the flange portion and to obtain a precise shape.

A slight warpage is found in the acoustic diaphragm 516 completed in this manner. When paper is milled and dried, the workpiece is pressurized. This production method is a cone production method so-called as a press cone method.

<Sixth Embodiment>

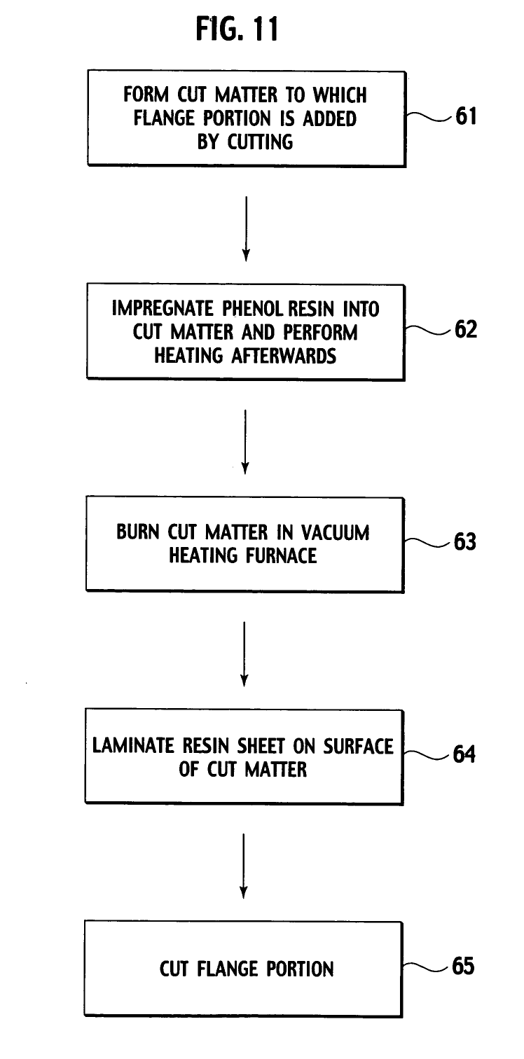

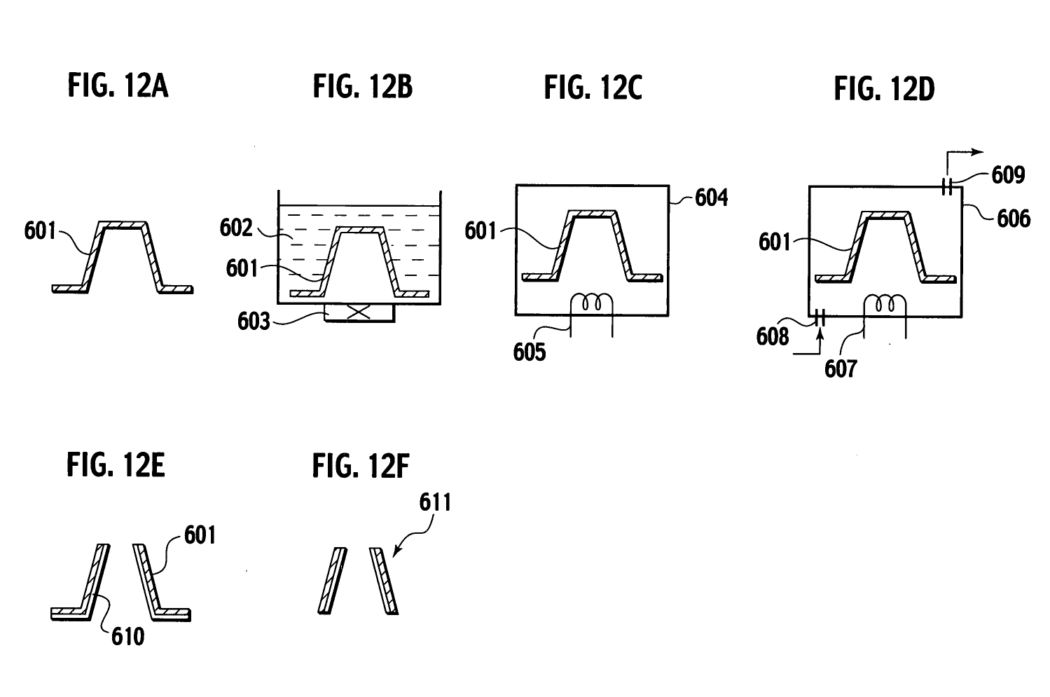

A sixth embodiment of the invention will be explained next. FIGS. 11 and 12A to 12F are explanatory diagrams of a production method according to the sixth embodiment.

At a first step 61 in FIG. 11, a block of a cypress which is a softwood is cut, thereby obtaining a cut matter 601 having a conical (truncated) portion and a flat (flange) portion formed at its lower end entire periphery (since the conical portion is contracted by the burning operation, this portion is formed larger than the size thereof after the burning operation. In this case, since it is heated at 800° C., contraction of 25% is taken into consideration, and the portion is formed larger by this value). At that time, the weight ratio between the conical portion and the flange portion is 1:1.3.

At a second step 62 in FIG. 11, as shown in FIG. 12B, the cut matter 601 is immersed in alcohol solution 602 of phenol resin (ratio of phenol resin is about 15%), and the solution 602 is impregnated therein. The entire phenol solution 602 in which the cut matter 601 is immersed is subjected to supersonic oscillation for five minutes for example by an ultrasonic oscillator 603 so that the solution 602 well enters the cut matter 601.

The cut matter 601 is taken out from the solution 602 and is sufficiently dried, and it is paced in a heating furnace 604 as shown in FIG. 12C and is heated for about 15 minutes at about 180° C. by a heater 605, and the phenol resin which is a short molecule is brought into a high polymer state.

Next, at a third step 63 in FIG. 11, as shown in FIG. 12D, the cut matter 601 in which phenol resin is brought into a high polymer state is placed in a vacuum heating furnace 606, and it is heated from a room temperature to 800° C. by a heater 607 in nitrogen gas atmosphere. After the cut matter 601 is held for 30 minutes at 800° C., it is gradually cooled to the room temperature and is taken out from the furnace. With this step, the organic matter included in the cut matter 601 is carbonized. Thus, a large number of fine holes are formed in the cut matter 601 so as to be porous.

A reference number 608 in FIG. 12D represents an introduction port for nitrogen gas, and a reference number 609 represents a discharge port for nitrogen gas. Argon gas or high vacuum atmosphere may be used instead of the nitrogen gas.

At a fourth step 64 in FIG. 11, as shown in FIG. 12E, a thin sheet 610 made of a predetermined material is laminated on a surface of the cut matter 601, thereby preventing air from leaking when it is formed as an acoustic diaphragm, and providing a function as the acoustic diaphragm.

At a fifth step 65 in FIG. 11, as shown in FIG. 12F, the flat portion of the flange of the cut matter 601 is eliminated by cutting to form an acoustic diaphragm 611.

At the time of the cutting operation at the first step 61 in FIG. 11 (at the time of FIG. 12A), if a small step is previously formed between the conical portion and the flange portion of the cut matter 601, it can be cut by a grinding cutter (cutting tool using a rotating grindstone), a laser cutter, or the like using the small step as a guideline, so it is possible to precisely eliminate the flange portion and to obtain a precise shape.

No warpage, contortion, or fracture is found in thus completed acoustic diaphragm 611.

When the workpiece in the first step of each of the embodiments is obtained by milling fiber such as pulp, and when it is obtained by cutting from wood, a relation between generation of warpage and the weight ratio of the diaphragm body portion (domical portion and conical portion) and its peripheral flat (flange) portion (the center flat portion is added in the case of the conical shape) is as follows:
1:0.0 Generation ratio of warpage is high, generation ratio of fracture is high;
1:0.5 Generation ratio of warpage is intermediate;
1:0.8 Generation ratio of warpage is small;
1:1 No warpage;
1:1.2 No warpage;
1:1.3 No warpage;
1:1.5 No warpage;
1:2 No warpage;
1:5 No warpage.

From the above relation, it can be found that the entire weight of the flange portion is greater than the entire weight of the diaphragm body portion.

Same relation is obtained even when the entire volume of the flange portion is greater than the entire volume of the diaphragm body portion.

It is preferable to form the flange portion into a flat surface shape projecting in a direction perpendicular to a moving direction of the diaphragm body portion. The flange portion may be formed over the entire outer periphery of the diaphragm body portion or may be formed on only a portion of the outer periphery.

<Seventh Embodiment>

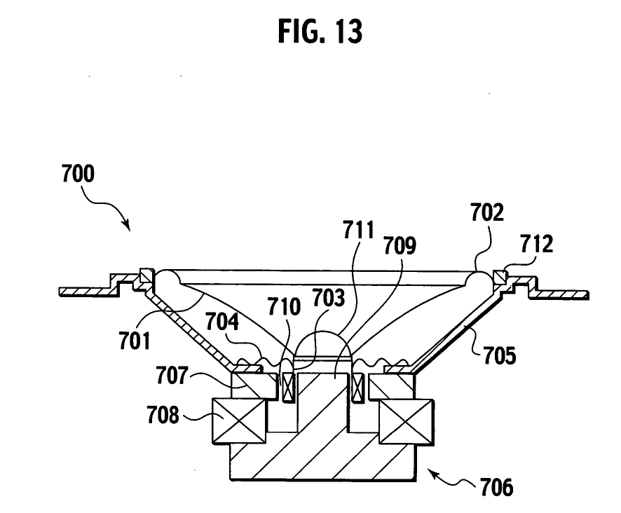

A seventh embodiment of the invention will be explained next. FIG. 13 is a cross section of a speaker according to the seventh embodiment.

According to a speaker 700, a rubber edge 702 having a predetermined shape is adhered to an entire outer periphery of a conical acoustic diaphragm 701 formed by any one of the production methods according to the first to the sixth embodiments, and a bobbin of a voice coil 703 having a predetermined shape (a predetermined damper 704 is previously adhered to the bobbin) is adhered to a center of the acoustic diaphragm 701.

These integral three parts are attached by adhesion to a predetermined speaker housing 705 (a predetermined magnetic circuit 706 is previously disposed). A conductive metal wire (not shown) is pulled out from the voice coil 703. The metal wire is connected to a terminal (not shown, and it is previously insulated from the metal housing 705) mounted on the housing 705.

The magnetic circuit 706 includes a ring-shaped plate 707, a ring-shaped magnet 708, a pole 709, and the like. The voice coil 703 is loosely inserted into a magnetic gap 710 formed between the plate 707 and the pole 709. The speaker is completed by polarizing the magnet 708.

A reference number 711 represents a dust cap for preventing a foreign matter from entering the voice coil 703. A reference number 712 represents an annular gasket for pressing an end of the edge 702.

As compared with a speaker having a wood acoustic diaphragm with the same shape, the speaker 700 has a high carbonization ratio, and has excellent acoustic properties with a clear reproduced sound having small distortion.

When the bobbin of the voice coil 703 is inserted into and adhered to the center portion of the acoustic diaphragm 701, the inner diameter of the center of the acoustic diaphragm 701 must just correspond to the outer diameter of the bobbin of the voice coil 703.

If a partial or a total relation of sizes satisfies “outer diameter of the bobbin of the voice coil 703”<<“inner diameter of the center of the acoustic diaphragm 701”, a gap between the inner and the outer diameters becomes large and much adhesive enters into the gap, thus, the adhesive layer becomes thick.

In a speaker in which it is ideal that movement of the bobbin of the voice coil 703 is directly transmitted to the acoustic diaphragm 701, a thick adhesive layer is not ideal.

If the partial or the total relation of sizes satisfies “outer diameter of the bobbin of the voice coil 703”>>“inner diameter of the center of the acoustic diaphragm 701”, the bobbin of the voice coil 703 can not be inserted into the center portion of the acoustic diaphragm 701, and it can not be assembled as a speaker.

Thus, the size before the burning operation must be determined by taking the size after the burning operation, a material to be burned, and the burning step into consideration. By doing so, the precision of the size after the burning operation is enhanced, and excellent acoustic properties can be exhibited as a speaker.

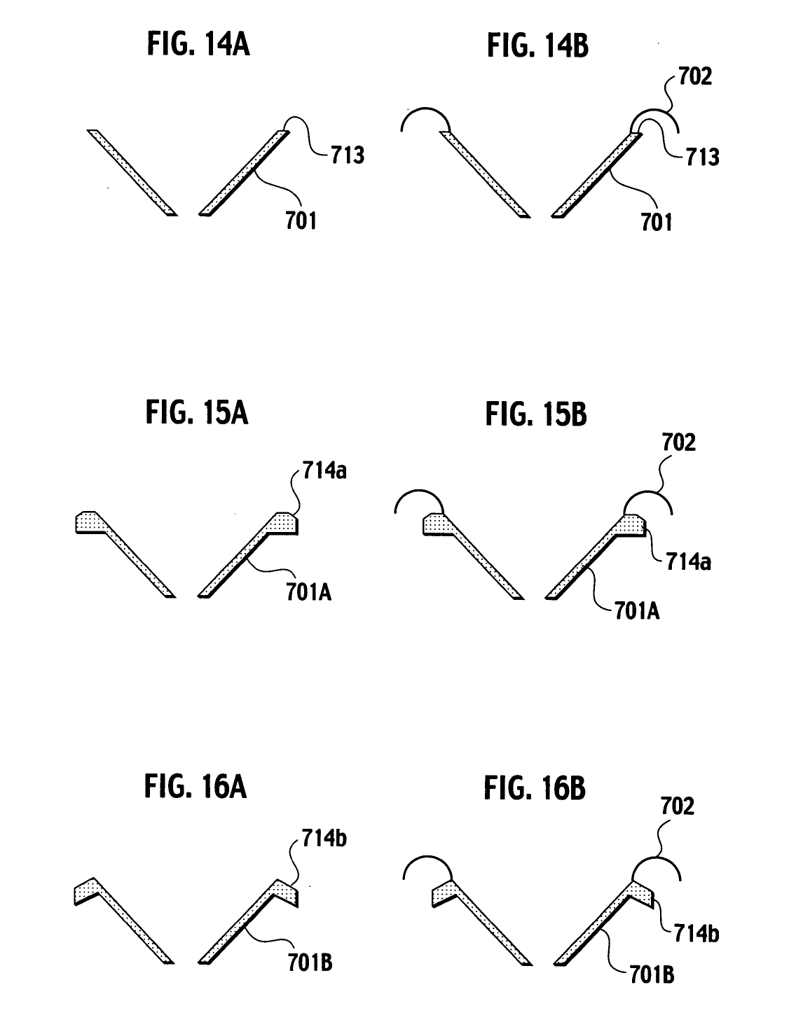

Each of the embodiments has been explained based on an example in which the flange portion is cut. When the acoustic diaphragm is formed by such a production method, for example, like the acoustic diaphragm 701 of the seventh embodiment, it has a cross sectional shape as shown in FIG. 14A, and a cut trace 713 of the flange portion remains on its outer periphery.

FIG. 14B shows a state where an edge 702 is mounted on this acoustic diaphragm 701.

When the flange portion is short enough to be ignorable, the cutting step of the flange portion may be omitted.

FIGS. 15A and 16A show examples of the acoustic diaphragm 701A, 701B produced by such a production method, and reference numbers 714a, 714b represent flange portions, respectively. FIGS. 15B and 16B show a state in which the edge 702 is mounted on the acoustic diaphragm 701A, 701B.

In some of the embodiments, the flange portion is cut after the air-leakage preventing processing, but the present invention is not limited to this, and the air-leakage preventing processing may be carried out after the flange portion is cut.

In some of the embodiments, the laminating processing is carried out as the air-leakage preventing processing, but the invention is not limited to this. For example, other materials having airtightness may be applied such as application of a gel silicon material and the like. The application of an airtight material and the laminating processing may be combined with each other.

As explained with reference to FIG. 13, when the acoustic diaphragm is assembled into the speaker, the edge is mounted on the outer periphery of the acoustic diaphragm, and the bobbin of the voice coil is adhered to the center portion. The important point is how the three integral parts, i.e., the acoustic diaphragm, the edge, and the bobbin of the voice coil are adhered without increasing the weight.

If air leaks from the acoustic diaphragm, this means that a fine hole leading from its front surface to its back surface exists in the acoustic diaphragm. At the time of an adhering operation, an adhesive enters the fine hole excessively deeply, which will increase the amount of adhesive, and the weight of the three parts is also increased as a result.

If the surface of the diaphragm is subjected to the laminating processing or if coating is applied to the surface of the diaphragm to prevent air-leakage, an opening of the fine hole appearing on the surface of the diaphragm can be closed, which will prevent the adhesive from entering into the fine hole excessively.

Therefore, prevention of air-leakage will reduce the weights of the acoustic diaphragm, the edge, and the voice coil to the minimum, thereby providing the acoustic diaphragm with a basic function necessary therefor.

Although only the conical shape and the domical shape are employed as the shape of the acoustic diaphragm in each of the embodiments, the present invention can also be applied to other acoustic diaphragm shapes, such as a flat shaped acoustic diaphragm.

The expression “substantially anoxic atmosphere” includes not only a completely vacuum atmosphere but also atmosphere including a slight amount of oxygen that does not adversely affect the product.

Various other modifications to the embodiments can be made without departing from the scope of the invention.

Examples of particularly effective products to which the present invention is applied are speakers used for high-class audio apparatuses, high-class home theater systems, monitors at a broadcast station, and the like. That is, these kinds of products are relatively small lots, and it is especially important to reduce the mold cost in terms of reduction of production cost.

According to the present invention, acoustic diaphragms that can achieve a high quality reproduced sound can be produced with excellent yield without using a press in burning operation. Therefore, when the present invention is applied to these kinds of products, a particularly significant effect can be expected in terms of reduction of cost.

It should be understood that many modifications and adaptations of the invention will become apparent to those skilled in the art and it is intended to encompass such obvious modifications and changes in the scope of the claims appended hereto.

What is claimed is:

1. A production method of an acoustic diaphragm comprising the steps of:
forming an acoustic diaphragm-shaped workpiece with a flange portion added to at least a portion of an outer periphery of the workpiece by using a natural material including an organic matter which can be carbonized by burning;
impregnating a solution including phenol resin into the workpiece obtained at the above step, and then heating the workpiece to a predetermined temperature to bring the phenol resin into a high polymer state; and
burning the workpiece processed at the above step under a substantially anoxic atmosphere to carbonize the organic matter.

2. The production method of the acoustic diaphragm according to claim 1, wherein a step of subjecting at least a portion of a surface of the workpiece to an air-leakage preventing processing to close a fine hole formed in the workpiece is provided after the step of carbonizing the organic matter.

3. The production method of the acoustic diaphragm according to claim 2, wherein a phenol resin solution is used in the air-leakage preventing processing.

4. The production method of the acoustic diaphragm according to claim 1, wherein at the step of forming the workpiece, in order to make the size of the workpiece become equal to a predetermined size after the burning, the workpiece is formed such that a size reduced by contraction at the time of burning is added to the predetermined size.

5. The production method of the acoustic diaphragm according to claim 1, wherein at the step of forming the workpiece, the workpiece is formed by milling and drying the workpiece in a nonpressurized state.

6. An acoustic diaphragm in which a workpiece is formed into an acoustic diaphragm shape by using a natural material including an organic matter which can be carbonized by burning, phenol resin is impregnated into the workpiece, the workpiece is heated and the phenol resin is brought into a high polymer state, the workpiece is burned under a substantially anoxic atmosphere, and the organic matter is carbonized, wherein
at least a portion of an outer periphery of the workpiece includes a cut trace of a flange portion or the flange portion.

7. A speaker that uses the acoustic diaphragm according to claim 6.
